(19) United States
(12) Patent Application Publication
(10) Pub. No.: US 2010/0257402 A1
(43) Pub. Date: Oct. 7, 2010

(54) DISK ARRAY DEVICE, AND MANAGEMENT METHOD AND PROGRAM OF DISK ARRAY DEVICE

(76) Inventor: SHUN KURITA, Tokyo (JP)

Correspondence Address: Mr. Jackson Chen, 6535 N. STATE HWY 161, IRVING, TX, 75039, US

(21) Appl. No.: 12/752,208

(22) Filed: Apr. 1, 2010

(30) Foreign Application Priority Data
Apr. 1, 2009 (JP) 2009-088831

(51) Int. Cl. G06F 11/00; G06F 12/00; G06F 11/20; G06F 11/16

(52) U.S. Cl. 714/7; 711/114; 714/47; 714/E11.062; 714/E11.088; 711/E12.001

(57) ABSTRACT

Provided is a disk array device which enables the amount of use of a physical disk to be reduced as much as possible even when there exist a plurality of logic extents of the same data. A disk array device which assigns, to a physical extent of a physical disk, a logic extent of a logic disk to which a host device makes an access, which device includes a data checking unit 14 which, at the time of assignment of the logic extent to the physical extent, checks identity of data of the logic extent and data of the physical extent already assigned, and an extent control unit 11 which, when a physical extent of the same data exists, assigns a plurality of the logic extents to the physical extent in question in overlap to manage assignment.

### INCORPORATION BY REFERENCE

This application is based upon and claims the benefit of priority from Japanese patent application No. 2009-088831, filed on Apr. 1, 2009, the disclosure of which is incorporated herein in its entirety by reference.

### TECHNICAL FIELD

The present invention relates to a disk array device and, more particularly, a disk array device which realizes reduction in a capacity to be used of a physical disk.

### BACKGROUND ART

Some of disk array devices have a function of setting up a logic disk having a virtual capacity by a plurality of physical disks (Hard Disk Drive (HDD)) and dynamically expanding a logic disk capacity according to writing processing from the side of a host. A disk array device having such a function enables posterior assignment of a physical disk.

In such a disk array device as described above, with assignable regions of a logic disk and a physical disk divided on a block basis (e.g. 256 MB) into logic extents and physical extents, respectively, the logic extents of the logic disk are made to correspond (assign) one-to-one to the physical extents to realize data read and write from/to the logic disk from the side of a host. Art related to such a disk array device is recited in Patent Literature 1, for example.

These logic extents and physical extents have their regions on the disk designated by a logic disk number (LDN) and a logic sector address (LSN), and a physical disk number (PDN) and a physical sector address (PSN), respectively.

Patent Literature 1: Japanese Patent Laying-Open No. 2008-217689.

In the disk array device recited in Patent Literature 1 or the like, while it is a common practice that a logic extent and a physical extent correspond one-to-one, when a plurality of logic extents of the same data exist, there arises a problem that assignment of as many physical extents as the number of the logic extents is required to decrease a usable capacity of a physical disk.

### OBJECT OF THE PRESENT INVENTION

An object of the present invention is to provide a disk array device, and a management method and a program of a disk array device which enable reduction in a capacity to be used of a physical disk even when there exist a plurality of logic extents of the same data.

### SUMMARY

According to a first exemplary aspect of the invention, a disk array device which assigns, to a physical extent of a physical disk, a logic extent of a logic disk to which a host device makes an access, includes a data checking unit which, at the time of assignment of the logic extent to the physical extent, checks identity of data of the logic extent and data of the physical extent already assigned, and a control unit which, when the physical extent of the same data exists, assigns a plurality of the logic extents to the physical extent in question in overlap to manage assignment.

According to a second exemplary aspect of the invention, a management method of a disk array device which assigns, to a physical extent of a physical disk, a logic extent of a logic disk to which a host device makes an access, includes a data checking step of, at the time of assignment of the logic extent to the physical extent, checking identity of data of the logic extent and data of the physical extent already assigned, and a control step of, when the physical extent of the same data exists, assigning a plurality of the logic extents to the physical extent in question in overlap to manage assignment.

According to a third exemplary aspect of the invention, a management program operable in a disk array device which assigns, to a physical extent of a physical disk, a logic extent of a logic disk to which a host device makes an access, which program causes the disk array device to execute a data checking processing of, at the time of assignment of the logic extent to the physical extent, checking identity of data of the logic extent and data of the physical extent already assigned, and a control processing of, when the physical extent of the same data exists, assigning a plurality of the logic extents to the physical extent in question in overlap to manage assignment.

The present invention enables the amount of use of a physical disk to be reduced as much as possible even when there exist a plurality of logic extents of the same data.

### BRIEF DESCRIPTION OF THE DRAWINGS

FIG. 1 is a block diagram showing a structure of a disk array device according to a first exemplary embodiment of the present invention;

FIG. 2 is a diagram showing an example of assignment of a physical extent and a logic extent according to the first exemplary embodiment;

FIG. 3 is a diagram showing an example of assignment of a physical extent and a logic extent according to the first exemplary embodiment;

FIG. 4 is a diagram showing an example of a structure of an extent assignment list according to the first exemplary embodiment;

FIG. 5 is a flow chart for use in explaining operation of data reading processing of the disk array device according to the first exemplary embodiment;

FIG. 6 is a flow chart for use in explaining operation of data writing processing executed when no overlap management is executed according to the first exemplary embodiment;

FIG. 7 is flow chart for use in explaining operation of data writing processing of the disk array device according to the first exemplary embodiment;

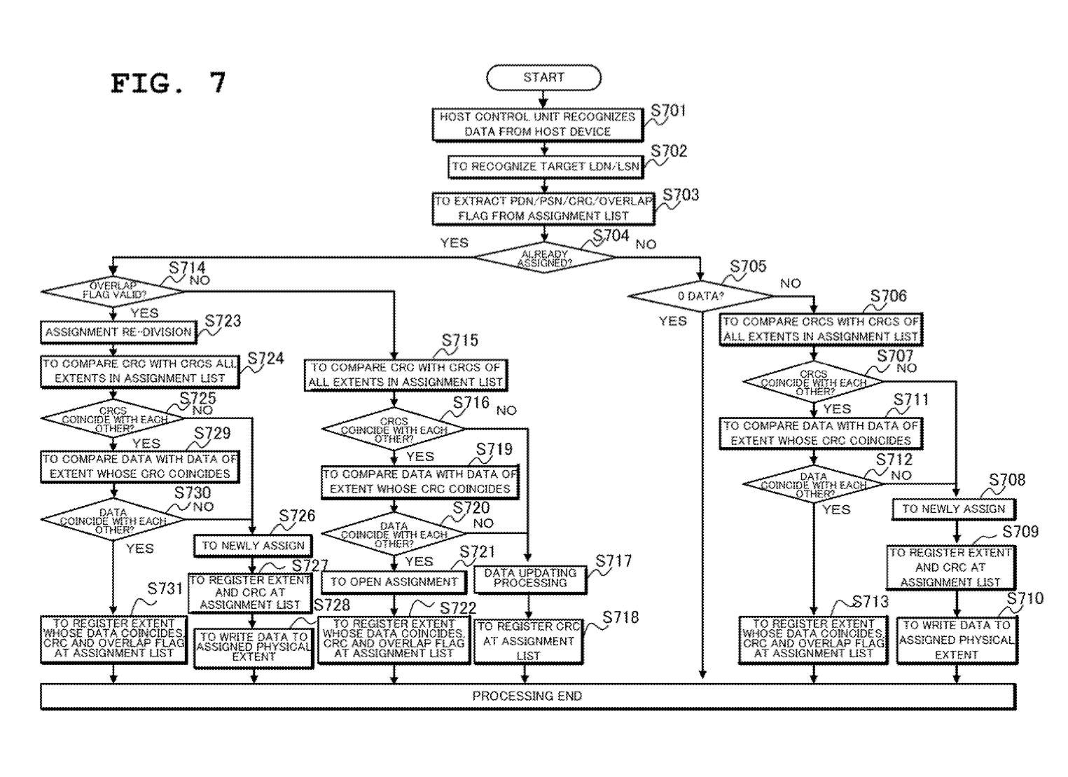

FIG. 8 is a block diagram showing a structure of a disk array device according to a second exemplary embodiment of the present invention;

FIG. 9 is a flow chart for use in explaining operation of the disk array device according to the second exemplary embodiment of the present invention; and

FIG. 10 is a block diagram showing an example of a hardware structure of a disk control unit of the disk array device according to the present invention.

### EXEMPLARY EMBODIMENT

Next, exemplary embodiments of the present invention will be described in detail with reference to the drawings.

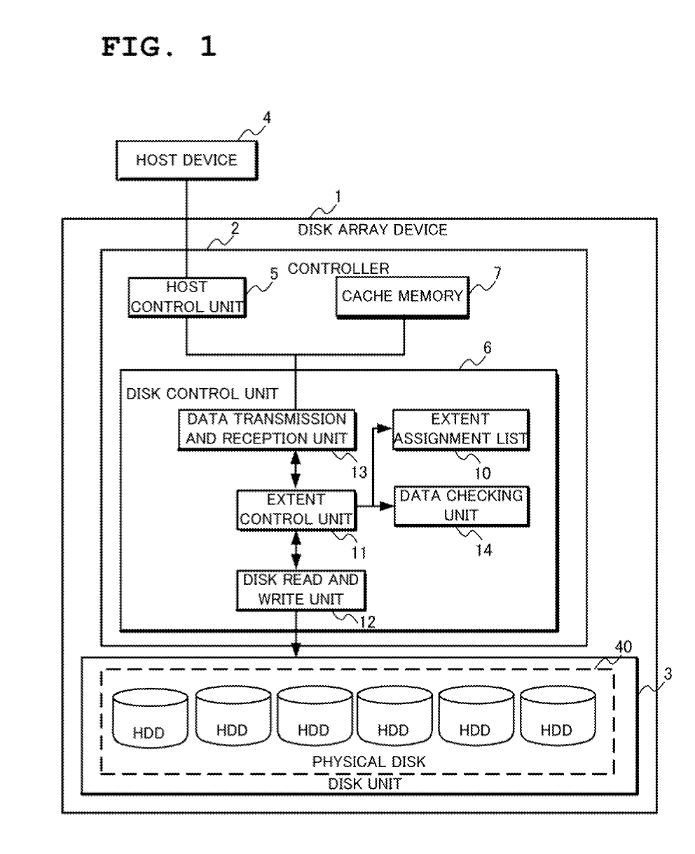

With reference to FIG. 1, a disk array device 1 according to the present invention has a controller 2, and a disk unit 3 formed of a plurality of physical disks (Hard Disk Drive (HDD)) 40.

The controller 2 has a host control unit 5 connected to a host device 4 for transmitting and receiving data to/from the host device 4, a disk control unit 6 connected to the disk unit 3 for reading and writing data from/to the physical disk 40, and a cache memory 7.

The cache memory 7 stores data to be transmitted and received between the host device 4 and the physical disk 40.

The disk control unit 6 has an extent assignment list storage unit 10, an extent control unit 11, a disk read and write unit 12, a data transmission and reception unit 13 and a data checking unit 14.

The extent assignment list storage unit 10 stores an extent assignment list 20 which records assignment information of a logic extent and a physical extent.

The extent control unit 11 changes the assignment list for assignment, as well as executing processing of controlling assignment of a logic extent and a physical extent.

The disk read and write unit 12 executes processing of reading and writing from/to the physical disk 40.

The data transmission and reception unit 13 transmits and receives data between the disk control unit 6, and the host control unit 5 and the cache memory 7.

The data checking unit 14 compares data to be written to a logic extent from the host device 4 and data of a physical extent in the physical disk 40. The data checking unit 14 also checks validity or invalidity of an overlap flag and identity of CRC included in assignment information of the extent assignment list 20.

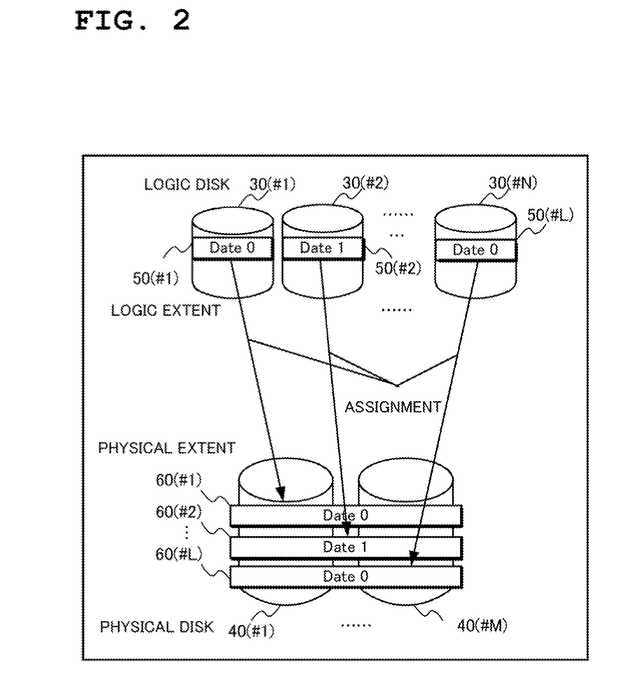

As shown in FIG. 2, a plurality of logic disks 30 (#1˜#N) are formed of a plurality of physical disks 40 (#1˜#M).

Illustrated in FIG. 2 is that a logic extent 50 (#1˜#L) of the logic disk 30 (#1˜#N) is assigned to a physical extent 60 (#1˜#L) of the physical disk 40 (#1˜#M).

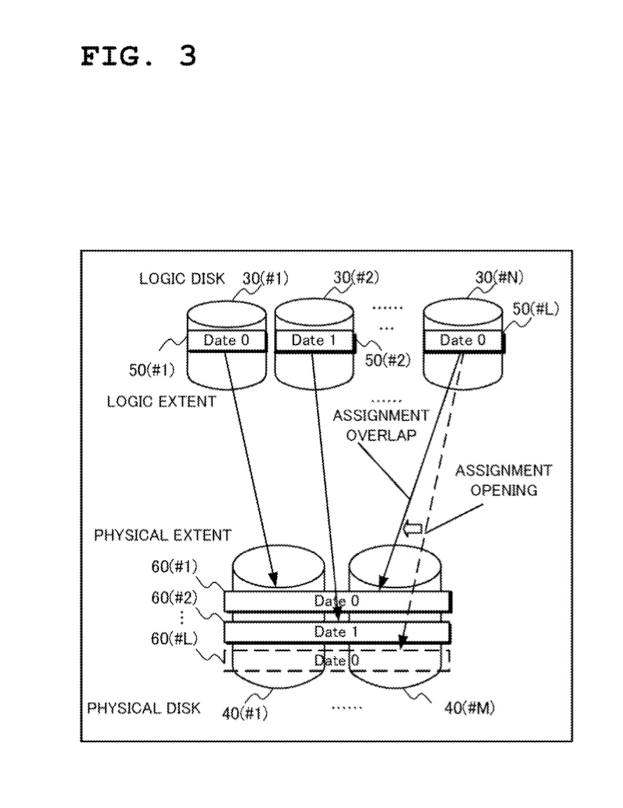

Shown in FIG. 3 is a case where when data of the physical extent 60 (#1) to which the logic extent 50 (#1) is assigned is the same as data of the physical extent 60 (#L) to which the logic extent 50 (#L) is assigned, assignment of the logic extent 50 (#L) and the physical extent 60 (#L) is opened to overlap with the logic extent 50 (#L).

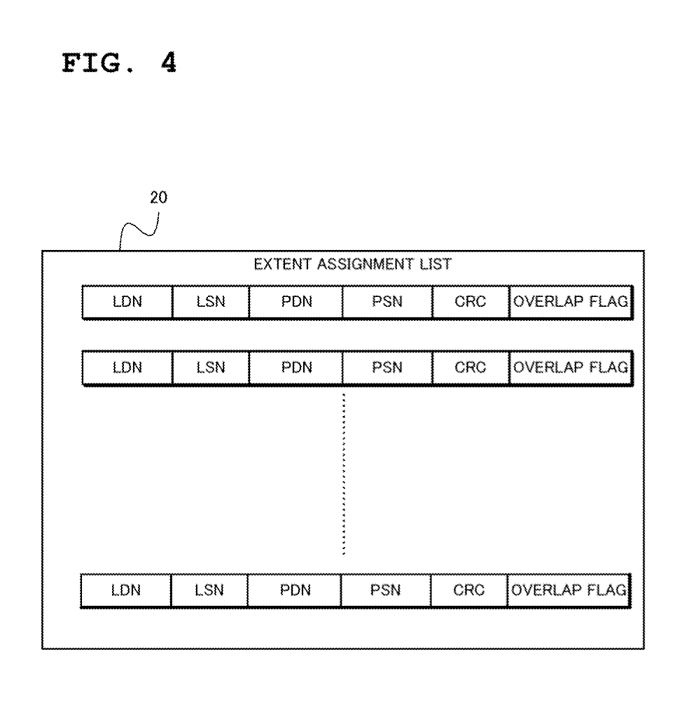

Also as shown in FIG. 4, stored in the extent assignment list 20 is assignment information including a logic disk number LDN and a logic sector address LSN of the logic disk 30 (#1˜#N), a physical disk number PDN and a physical sector address PSN of its corresponding physical disk 40 (#1˜#M), and CRC (Cyclic Redundancy Check) of data of a physical extent indicated by PDN and PSN, and an overlap flag.

With reference to such extent assignment list 20 as shown in FIG. 4, the extent control unit 11 executes new assignment of a logic extent and a physical extent, assignment change and assignment opening, as well as executing registration, change and deletion of assignment information of the extent assignment list 20.

### (Operation of the First Exemplary Embodiment)

Next, description will be made of operation of thus structured disk array device 1 according to the present exemplary embodiment as shown in FIG. 1 with reference to FIG. 2 through FIG. 6.

(Processing to be Executed when Receiving Read Request from the Host Device 4)

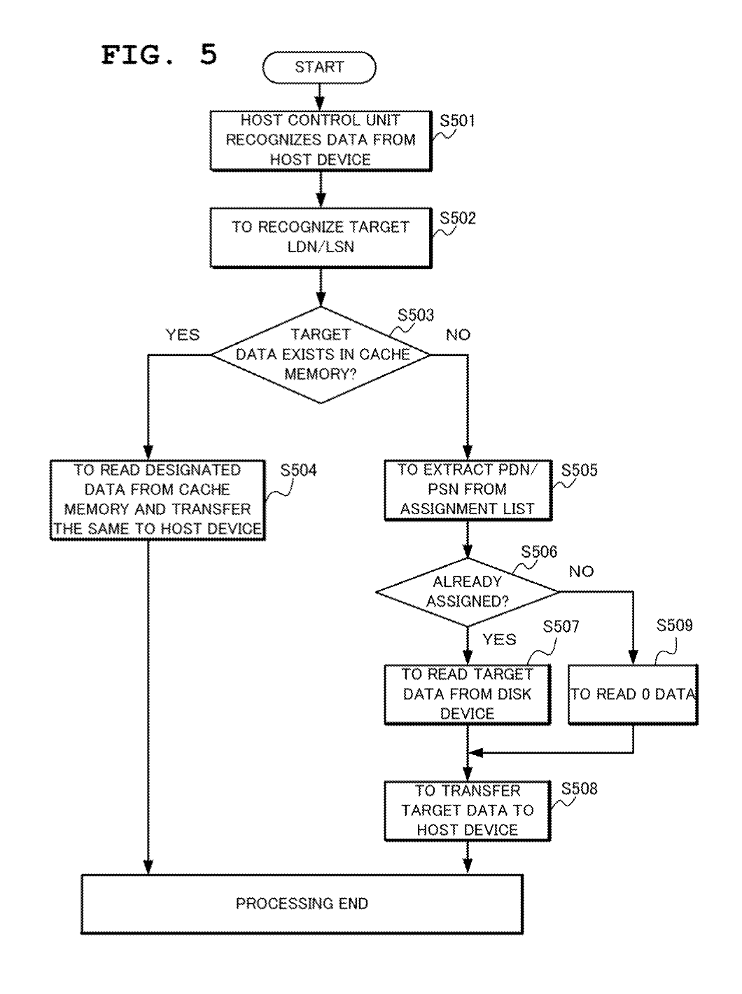

First, description will be made of operation of the disk array device 1 to be executed when receiving a read request from the host device 4 with reference to the flow chart in FIG. 5.

The host control unit 5 having received a read request from the host device 4 recognizes necessary information such as a logic disk number LDN and a logic sector address LSN of a logic extent, and a kind of instruction code (Step S501).

Upon recognizing the logic disk number LDN and the logic sector address LSN transferred to the data transmission and reception unit 13 (Step S502), the extent control unit 11 determines whether designated data exists in the cache memory 7 (Step S503).

When the designated data exists in the cache memory 7, immediately read the designated data from the cache memory 7 and transfer the same to the host device 4 (Step S504).

When the data in question fails to exist in the cache memory 7, the disk control unit 6 will read the designated data from the disk unit 3 to transfer the same to the host control unit 5.

The extent control unit 11 extracts, from the extent assignment list 20, a physical disk number PDN and a physical sector address PSN corresponding to the logic disk number LDN and the logic sector address LSN of the data reading target transferred to the data transmission and reception unit 13 (Step S505).

The extent control unit 11 determines whether the target logic disk number LDN and logic sector address LSN are already assigned or not (Step 506).

When they are already assigned, the extent control unit 11 causes the disk read and write unit 12 to execute processing of data reading from the target physical extent 60 (Step S507). Then, transfer the read data to the host device 4 through the data transmission and reception unit 13 (Step S508).

When the target logic disk number LDN and logic sector address LSN are yet to be assigned, read zero data (Step S509) and transfer the same to the host device 4 (Step S508).

(Processing to be Executed when Receiving Write Request from the Host Device 4)

Next, description will be made of operation of the disk array device 1 to be executed when receiving a write request from the host device 4.

The disk array device 1 according to the present exemplary embodiment is characterized in, at the execution of assignment of a logic disk and a physical disk, checking identity with data in a physical extent and when the data is the same, executing overlap management of a physical extent of the same data without executing new assignment.

For clarifying the characteristics of the present exemplary embodiment, description will be here first made of operation executed in a case where when receiving a write request from the host device 4, neither check of identity with data in a physical extent nor overlap management of a physical extent of the same data is executed.

The host control unit 5 having received a write request from the host device 4 transfers data received from the host device 4 to the disk control unit 6, and the disk control unit 6 executes processing of writing to the physical disk 40. The write processing in this case is executed by a procedure shown in the flow chart in FIG. 4.

The host control unit 5 having received the write request from the host device 4 recognizes necessary information such as a logic disk number LDN and a logic sector address LSN of a logic extent, and a kind of instruction code (Step S601).

Upon recognizing the logic disk number LDN and the logic sector address LSN transferred to the data transmission and reception unit 13 (Step S602), the extent control unit 11 extracts a physical disk number PDN and physical sector address PSN corresponding to the logic disk number LDN and the logic sector address LSN transferred to the data transmission and reception unit 13 from the extent assignment list 20 (Step S603).

The extent control unit 11 determines whether the target logic disk number LDN and logic sector address LSN are already assigned or not (Step S604).

When they are already assigned, cause the disk read and write unit 12 to execute processing of data writing to a target physical extent 60 without changing the extent assignment list 20 (without changing assignment) (Step S605).

When the target logic disk number LDN and logic sector address LSN are yet to be assigned, determine whether the data to be written is zero data (Step S606) and when it is zero data, end the processing without executing new assignment (Step S607).

When it is not zero data, the extent control unit 11 refers to the extent assignment list 20 to extract an assignable region of the physical disk 40 and registers, at the extent assignment list 20, the logic disk number LDN and the logic sector address LSN of the target logic extent and a physical disk number and a physical sector address PSN of a physical extent as the extracted region to execute new assignment (Step S608).

After completion of the registration at the extent assignment list 20, the extent control unit 11 causes the disk read and write unit 12 to execute data writing processing of writing the write data from the host device 4 into the newly assigned physical extent (Step S609).

As described above, in a case where no check of identity with data in a physical extent is executed and no overlap management of a physical extent of the same data is executed, when a zero data write request is received from the host device 4 related to a logic disk number LDN and a logic sector address LSN yet to be assigned, refraining from executing new assignment enables reduction in a capacity to be used of the physical disk 40. When receiving other data write request, however, because assignment is newly executed without checking identity with data and executing overlap management of a physical extent of the same data, a plurality of physical extents of the same data might exist in overlap in the physical disk 40.

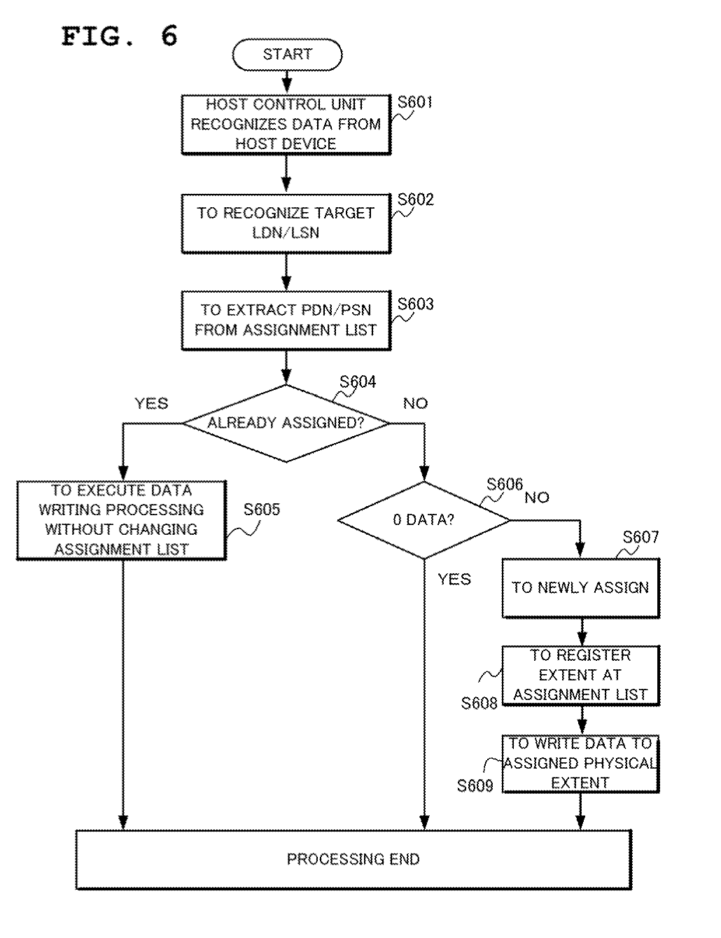

Next, description will be made of operation of checking identity with data in a physical extent and executing overlap management of a physical extent of the same data according to the present exemplary embodiment with reference to the flow chart of FIG. 6.

The host control unit 5 having received a data write request from the host device 4 recognizes necessary information such as a logic disk number LDN and a logic sector address LSN of a logic extent, and a kind of instruction code (Step S701).

Upon recognizing the logic disk number LDN and the logic sector address LSN transferred to the data transmission and reception unit 13 (Step S702), the extent control unit 11 of the disk control unit 6 extracts, from the extent assignment list 20, a physical disk number PDN, a physical sector address PSN, CRC and an overlap flag corresponding to the logic disk number LDN and the logic sector address LSN transferred to the data transmission and reception unit 13 (Step S703).

The extent control unit 11 determines whether the target logic disk number LDN and logic sector address LSN are already assigned or not (Step S704).

When the target logic disk number LDN and logic sector address LSN are yet to be assigned, determine whether the data to be written is zero data (Step S705) and when it is zero data, end the processing without executing new assignment.

When it is not zero data, before execution of new assignment, the extent control unit 11 causes the data checking unit 14 to compare the write data from the host device 4 and data of all the physical extents 60 registered in the extent assignment list 20.

First, the data checking unit 14 compares the CRC of the write data from the host device 4 and CRCs of the all the physical extents 60 registered in the extent assignment unit 20 (Steps S706 and S707).

When CRCs fail to coincide with each other, the extent control unit 11 refers to the extent assignment list 20 to extract an assignable region of the physical disk 40 and newly assign the target logic extent and a physical extent as the extracted region (Step S708).

Then, register the logic disk number LDN and the logic sector address LSN of the target logic extent, and a physical disk number, a physical sector address PSN and a CRC of the physical extent as the extracted region at the extent assignment list 20 (Step S709). In this case, no overlap flag is registered in the extent assignment list 20.

After completion of the registration at the extent assignment list 20, the extent control unit 11 causes the disk read and write unit 12 to execute data writing processing of writing the write data from the host device 4 into the newly assigned physical extent (Step S710). Thereafter, end the processing.

When CRCs coincide with each other, the data checking unit 14 compares the write data from the host device 4 and data of all the physical extents whose CRCs coincide (Steps S711 and S712).

When the data coincide with each other, the extent control unit 11, without executing new assignment, registers the write target logic disk number LDN and logic sector address LSN from the host device 4, the physical disk number PDN and the physical sector address PSN of the physical extent 60 whose data coincides, a data CRC and an overlap flag at the extent assignment list 20 (Step S713). Thereafter, end the processing.

When the data fail to coincide with each other, execute new assignment at Step S708, registration at the extent assignment list 20 at Step S709 and data writing processing at Step S710.

When the target logic disk number LDN and logic sector address LSN are already assigned at Step S704, determine whether an overlap flag is already registered at the entry of the write target logic disk number LDN and logic sector address LSN in the extent assignment list 20 (Step S714).

When no overlap flag is registered, the data checking unit 14 compares the CRC of the write data from the host device 4 and CRCs of all the physical extents 60 registered at the extent assignment list 20 (Steps S715 and S716).

When the CRCs fail to coincide with each other, execute data updating processing of updating data of a physical extent by the write data from the host device 4 without changing the assignment (Step S717) to register the CRC of the write data at a corresponding entry in the extent assignment list 20 (Step S718). In this case, no overlap flag is registered at the extent assignment list 20.

When the CRCs coincide with each other, compare the write data from the host device 4 and data of all the physical extents whose CRCs are coincident (Steps S719 and S720).

When the data fail to coincide with each other, execute the data updating processing at Step S717 and registration of the CRC of the data at the extent assignment list 20 at Step S718.

When the data coincide with each other, the extent control unit 11 extracts, from the extent assignment list 20, a physical extent 60 corresponding to the write target logic disk number LDN and logic sector address LSN from the host device 4 to open the assignment of the extracted physical extent 60 (Step S721). In other words, delete the physical disk number PDN and the physical sector address PSN of the extracted physical extent in question from the assignment information of the extracted physical extent 60.

After opening the assignment, register the logic disk number LDN and the logic sector address LSN of the write target logic extent, a physical disk number PDN and a physical sector address PSN of the physical extent 60 whose data coincides in the above-described data comparison in the extent assignment list 20, the CRC of the write data and an overlap flag (Step S722).

When at Step S714, an overlap flag is registered at the write target logic disk number LDN and logic sector address LSN in the extent assignment list 20, before the writing processing, delete (clear) a physical disk number PDN, a physical sector address PSN and an overlap flag corresponding to the write target logic disk number LDN and logic sector address LSN in the extent assignment list 20 (assignment re-division) (Step S723).

Thereafter, the data checking unit 14 compares the CRC of the write data from the host device 4 and CRCs of all the physical extents 60 registered in the extent assignment list 20 (Steps S724 and S725).

When the CRCs fail to coincide with each other, the extent control unit 11 refers to the extent assignment list 20 to extract an assignable region of the physical disk 40 to newly assign the target logic extent and a physical extent which is the extracted region (Step S726).

Then, register, at the extent assignment list 20, the logic disk number LDN and the logic sector address LSN of the target logic extent, and a physical disk number, a physical sector address PSN and a CRC of the physical extent which is the extracted region (Step S727). In this case, no overlap flag is registered at the extent assignment list 20.

After the completion of the registration at the extent assignment list 20, the extent control unit 11 causes the disk read and write unit 12 to execute the data writing processing of writing the write data from the host device 4 to a newly assigned physical extent (Step S728). Thereafter, end the processing.

When the CRCs coincide with each other, compare the write data from the host device 4 and data of all the physical extents whose CRCs are coincident (Steps S729 and S730).

When the data coincide with each other, without newly executing assignment, the extent control unit 11 registers, at the extent assignment list 20, the write target logic disk number LDN and logic sector address LSN from the host device 4, a physical disk number PDN and a physical sector address PSN of the physical extent 60 whose data coincides, the CRC of the data and an overlap flag (Step S731). Thereafter, end the processing.

When the data fail to coincide with each other, execute new assignment at Step S726, registration at the extent assignment list 20 at Step S727 and the data writing processing at Step S728.

As described in the foregoing, in a case where a plurality of logic disk numbers LDNs and logic sector addresses LSNs correspond to one physical disk number PDN and physical sector address PSN, upon a read request from the host device 4, referring to the extent assignment list 20 enables reading processing to be realized by the procedure shown in FIG. 5.

### (Effects of the First Exemplary Embodiment)

According to the first exemplary embodiment, when there exist a plurality of assignments of the logic extent 50 and the physical extent 60 whose data is the same, by assigning a plurality of logic extents to one physical extent in overlap and opening the assignment to other physical extent, a capacity to be used of the physical disk 40 can be reduced. The reason is that with a plurality of physical extents of the same data considered as one physical extent, assigning the physical extent to a plurality of logic extents in overlap allows a storage region of the physical disk assigned as a physical extent to be used as a new physical extent or as other data region.

In addition, because when data of a certain logic extent among the plurality of logic extents assigned to one physical extent in overlap is updated, overlap management of the logic extent is released to assign a new physical extent, data updating processing can be unlimitedly executed even after overlap management.

### SECOND EXEMPLARY EMBODIMENT

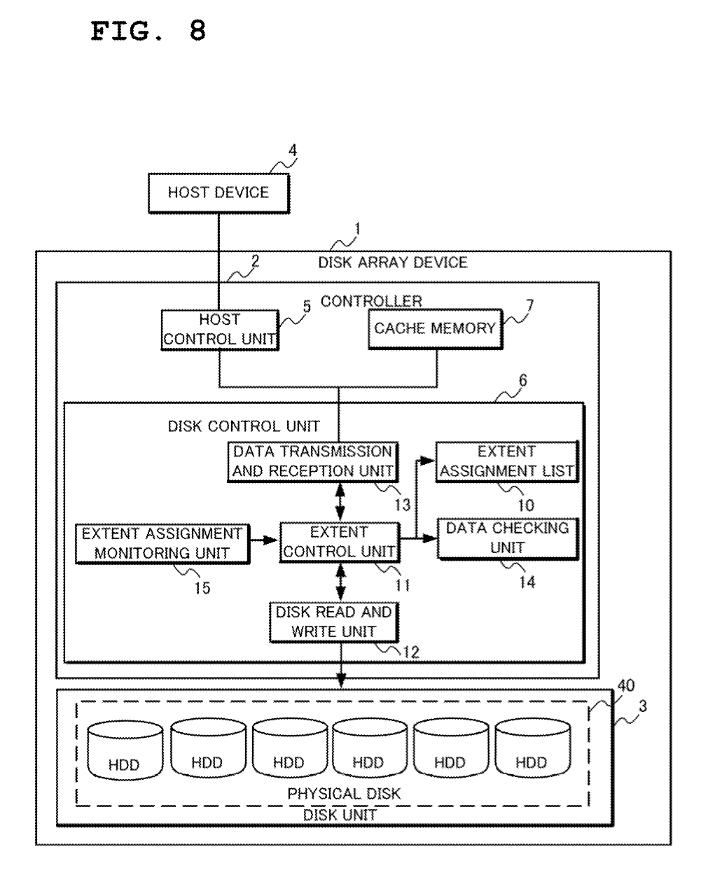

An example of a structure of a disk array device according to a second exemplary embodiment of the present invention is shown in FIG. 8.

In the first exemplary embodiment, execution of data check by the data checking unit 14 in synchronization with the processing of writing from the host device 4 might affect device performance. Therefore, the disk array device according to the second exemplary embodiment has an extent assignment monitoring unit 15 added to the disk control unit 6 as shown in FIG. 8.

The other components than the extent assignment monitoring unit 15 are the same as those of the first exemplary embodiment shown in FIG. 1, whose description will be therefore omitted.

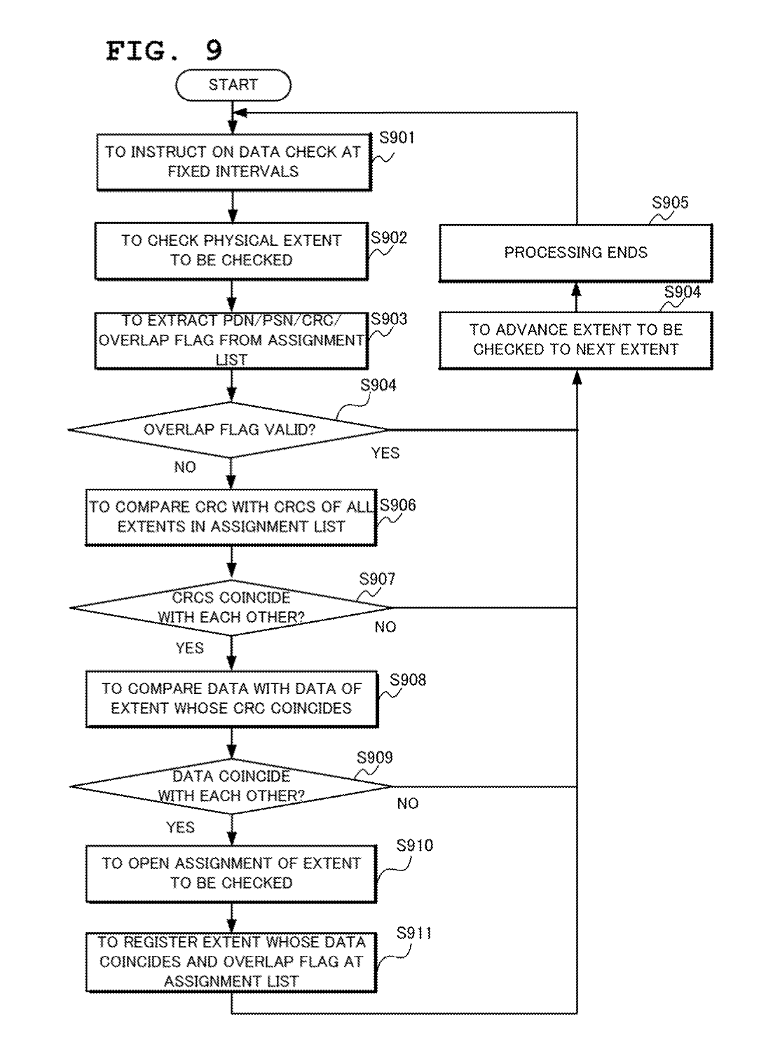

In the following, operation executed using the extent assignment monitoring unit 15 of the disk array device according to the second exemplary embodiment will be described with reference to FIG. 9.

The extent assignment monitoring unit 15 issues an instruction to the data checking unit 14 through the extent control unit 11 on checking of assignment information and data identity check at fixed time intervals (Step S901).

The data checking unit 14 having received the instruction sequentially checks the physical extents 60 registered at the extent assignment list 20 (Step S902).

First, from the extent assignment list 20, extract a physical disk number PDN, a physical sector address PSN, a CRC and an overlap flag of a physical extent to be checked (Step S903) to determine whether the overlap flag of the physical extent to be checked is registered or not (Step S904).

When, it is registered, advance a physical extent 60 to be checked to a next extent in the extent assignment list 20 to end the processing (Steps S904 and S905) and wait for a subsequent data check instruction.

When the overlap flag is not registered, next compare the CRC of the physical extent to be checked and CRCs of all the physical extents 60 registered in the extent assignment list 20 (Steps S906 and S907).

When the CRCs fail to coincide with each other, advance a physical extent 60 to be checked to a next extent in the extent assignment list 20 to end the processing (Steps S904 and 5905) and wait for a subsequent data check instruction.

When the CRCs coincide with each other, compare the data of the check target physical extent 60 and data of all the physical extents whose CRCs are coincident (Steps S908 and S909).

When the data coincide with each other, the extent control unit 11 opens assignment of the physical extent to be checked (delete a physical disk number PDN and a physical sector address PSN of the physical extent to be checked from the assignment information of the physical extent to be checked) and registers, in the assignment information in the extent assignment list 20, a physical disk number PDN, a physical sector address PSN and an overlap flag of the physical extent whose data coincides in the above-described data comparison (Step S909).

When the data fail to coincide with each other, advance an extent to be checked to a next extent in the extent assignment list 20 and end the processing to wait for a subsequent data check instruction (Steps S904 and S905). Repeat the above-described processing at fixed intervals.

The data reading processing and the data writing processing according to the second exemplary embodiment are executed by the procedures shown in FIG. 5 and FIG. 6.

### (Effects of the Second Exemplary Embodiment)

According to the second exemplary embodiment, similarly to the first exemplary embodiment, when there exist a plurality of assignments of the logic extent 50 and the physical extent 60 whose data is the same, by assigning a plurality of logic extents to one physical extent in overlap and opening the assignment to other physical extent, a capacity to be used of the physical disk 40 can be reduced.

In addition, since without executing data identity check, assignment opening and overlap management in synchronization with the processing of writing from the host device 4, the writing processing is executed based on an identity check instruction issued at fixed intervals from the extent assignment monitoring unit 15, the processing of writing from the host device 4 will be facilitated to mitigate effects on the performance of the disk array device.

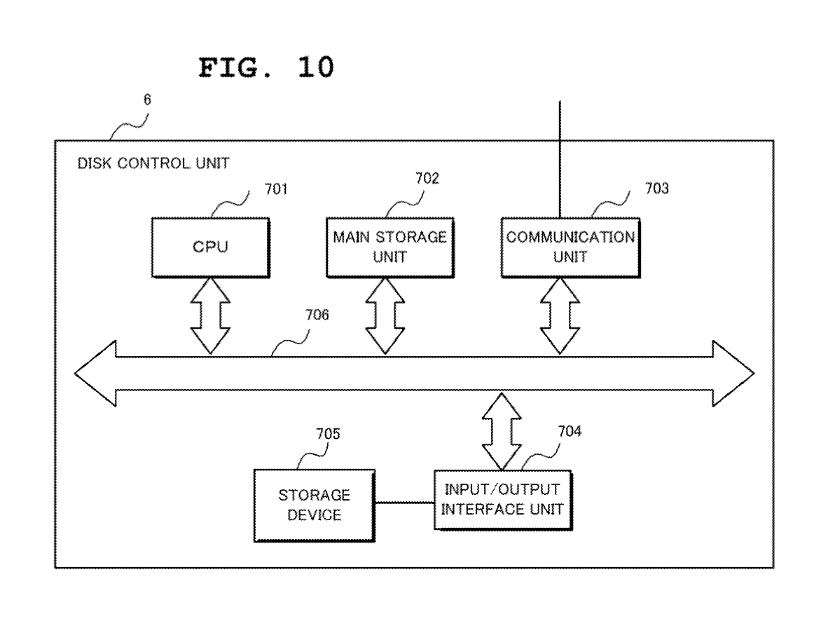

Lastly, description will be made of an example of a hardware structure of the disk control unit 6 of the disk array device 1 with reference to FIG. 10.

As shown in FIG. 10, the disk control unit 6, which can be realized by the same hardware structure as that of a common computer device, comprises a CPU (Central Processing Unit) 701, a main storage unit 702 for use as a data working region or a data temporary saving region formed of a RAM (Random Access Memory) or the like, a communication unit 703 which transmits and receives data, an input/output interface unit 704 connected with a storage device 705 for transmitting and receiving data, and a system bus 706 which connects the above-described components with each other. The storage device 705 is formed, for example, of a non-volatile memory such as a ROM (Read Only Memory), a magnetic disk or a semiconductor memory.

The disk control unit 6 has its operation realized not only in hardware by mounting a circuit part as a hardware part such as an LSI (Large Scale Integration) with a program incorporated therein but also in software by storing a program which provides the functions of the extent control unit 11, the data checking unit 14, the extent assignment monitoring unit 15 and the like into the storage device 705 and loading the program into the main storage unit 702 to execute the same by the CPU 701.

Although the present invention has been described with respect to the preferred exemplary embodiments and modes of implementation in the foregoing, the present invention is not necessarily limited to the above-described exemplary embodiments and modes of implementation and can be implemented in various modifications without departing from the scope of their technical ideas.

The whole or part of the exemplary embodiments disclosed above can be described as, but not limited to, the following supplementary notes.

(Supplementary note 1) A disk array device which assigns, to a physical extent of a physical disk, a logic extent of a logic disk to which a host device makes an access, comprising

a data checking unit which, at the time of assignment of the logic extent to the physical extent, checks identity of data of the logic extent and data of the physical extent already assigned; and

a control unit which, when the physical extent of the same data exists, assigns a plurality of the logic extents to the physical extent in question in overlap to manage assignment.

(Supplementary note 2) The disk array device according to Supplementary note 1, further comprising

an extent assignment list which registers assignment information including a state of assignment of the logic extent and the physical extent and an overlap flag indicating that the plurality of the logic extents are assigned in overlap, wherein

when executing new assignment, assignment change and assignment opening of the logic extent and the physical extent, the control unit, registers, changes and deletes the assignment information of the extent assignment list.

(Supplementary note 3) The disk array device according to Supplementary note 2, wherein

when a data write request is made to the logic extent yet to be assigned to the physical extent, the data checking unit compares write data and data of all the physical extents in the extent assignment list,

when the data coincide with each other, the control unit makes the logic extent as a write target correspond to a physical extent whose data coincides and registers assignment information whose overlap flag is set to be valid at the extent assignment list without executing writing processing of the write data, and

when the data fail to coincide with each other, the control unit assigns the logic extent as a write target to new the physical extent and registers assignment information including the assignment state in question and an invalid overlap flag at the extent assignment list to execute processing of writing the write data to the physical extent assigned.

(Supplementary note 4) The disk array device according to Supplementary note 2, wherein

when a data write request is made to the logic extent already assigned to the physical extent, the control unit determines whether an overlap flag of the assignment information in the extent assignment list is valid or not,

when the overlap flag fails to be valid, the data checking unit compares the write data and data of all the physical extents in the extent assignment list,

when the data coincide with each other, the control unit opens assignment to a physical extent whose data coincides, makes the logic extent as a write target correspond to the physical extent whose data coincides and registers assignment information whose overlap flag is set to be valid at the extent assignment list without executing processing of writing the write data, and

when the data fail to coincide with each other, the control unit executes processing of writing the write data to the physical extent assigned to the logic extent as a write target.

(Supplementary note 5) The disk array device according to Supplementary note 4, wherein

when the overlap flag is valid,

the control unit clears assignment information about the logic extent as a write target, and

the data checking unit compares the write data and data of all the physical extents in the extent assignment list,

when the data coincide with each other, the control unit makes the logic extent as a write target correspond to a physical extent whose data coincides and registers assignment information whose overlap flag is set to be valid at the extent assignment list without executing processing of writing the write data, and

when the data fail to coincide with each other, the control unit assigns the logic extent as a write target to new the physical extent and registers assignment information including the assignment state in question and an invalid overlap flag at the extent assignment list to execute processing of writing the write data to the physical extent assigned.

(Supplementary note 6) The disk array device according to Supplementary note 2, wherein

the assignment information includes a CRC of data of the physical extent assigned,

wherein when registering or changing the assignment information in the extent assignment list, the control unit includes the CRC of the data of the physical extent in the assignment information.

(Supplementary note 7) A disk array device which assigns, to a physical extent of a physical disk, a logic extent of a logic disk to which a host device makes an access, comprising:

an extent assignment list which registers assignment information including a state of assignment of the logic extent and the physical extent and an overlap flag indicating that a plurality of the logic extents are assigned in overlap;

a data checking unit which checks data of the physical extents assigned in the extent assignment list and the assignment information;

a monitoring unit which instructs the data checking unit to check at fixed time intervals; and

a control unit which, when the physical extent of the same data exists, assigns the plurality of the logic extents to the physical extent in question in overlap to manage assignment.

(Supplementary note 8) The disk array device according to Supplementary note 7, wherein

the data checking unit

checks the physical extents assigned in the extent assignment list one by one at each reception of an instruction from the monitoring unit, and

when an overlap flag of the assignment information of the physical extent is invalid, compares data of a physical extent to be checked and data of all the physical extents in the extent assignment list, and

when the data coincide with each other, the control unit opens assignment of the physical extent to be checked to assign other physical extent whose data coincides in the extent assignment list and set the overlap flag to be valid.

(Supplementary note 9) A management method of a disk array device which assigns, to a physical extent of a physical disk, a logic extent of a logic disk to which a host device makes an access, comprising:

a data checking step of, at the time of assignment of the logic extent to the physical extent, checking identity of data of the logic extent and data of the physical extent already assigned, and

a control step of, when the physical extent of the same data exists, assigning a plurality of the logic extents to the physical extent in question in overlap to manage assignment.

(Supplementary note 10) The management method of a disk array device according to Supplementary note 9, comprising:

an extent assignment list which registers assignment information including a state of assignment of the logic extent and the physical extent and an overlap flag indicating that the plurality of the logic extents are assigned in overlap, wherein

when executing new assignment, assignment change and assignment opening of the logic extent and the physical extent at the control step, registration, change and deletion of the assignment information of the extent assignment list are executed.

(Supplementary note 11) The management method of a disk array device according to Supplementary note 10, wherein

when a data write request is made to the logic extent yet to be assigned to the physical extent, at the data checking step, write data and data of all the physical extents in the extent assignment list are compared, and

when the data coincide with each other, at the control step, the logic extent as a write target is made to correspond to a physical extent whose data coincides to register assignment information whose overlap flag is set to be valid at the extent assignment list without executing writing processing of the write data, and

when the data fail to coincide with each other, at the control step, the logic extent as a write target is assigned to new the physical extent and assignment information including the assignment state in question and an invalid overlap flag is registered at the extent assignment list to execute processing of writing the write data to the physical extent assigned.

(Supplementary note 12) The management method of a disk array device according to Supplementary note 10, wherein

when a data write request is made to the logic extent already assigned to the physical extent, at the control step, determination is made whether an overlap flag of the assignment information in the extent assignment list is valid or not, and

when the overlap flag fails to be valid, at the data checking step, the write data and data of all the physical extents in the extent assignment list are compared, and

when the data coincide with each other, at the control step, assignment to a physical extent whose data coincides is opened to make the logic extent as a write target correspond to the physical extent whose data coincides and register assignment information whose overlap flag is set to be valid at the extent assignment list without executing processing of writing the write data, and

when the data fail to coincide with each other, at the control step, processing is executed of writing the write data to the physical extent assigned to the logic extent as a write target.

(Supplementary note 13) The management method of a disk array device according to Supplementary note 12, wherein

when the overlap flag is valid,

at the control step, assignment information about the logic extent as a write target is cleared, and

at the data checking step, the write data and data of all the physical extents in the extent assignment list are compared, and

when the data coincide with each other, at the control step, the logic extent as a write target is made to correspond to a physical extent whose data coincides to register assignment information whose overlap flag is set to be valid at the extent assignment list without executing processing of writing the write data, and

when the data fail to coincide with each other, at the control step, the logic extent as a write target is assigned to new the physical extent to register assignment information including the assignment state in question and an invalid overlap flag at the extent assignment list and execute processing of writing the write data to the physical extent assigned.

(Supplementary note 14) The management method of a disk array device according to Supplementary note 10, wherein

the assignment information includes a CRC of data of the physical extent assigned, and

when registering or changing the assignment information in the extent assignment list at the control step, the CRC of the data of the physical extent is included in the assignment information.

(Supplementary note 15) A management method of a disk array device which assigns, to a physical extent of a physical disk, a logic extent of a logic disk to which a host device makes an access, comprising:

an extent assignment list which registers assignment information including a state of assignment of the logic extent and the physical extent and an overlap flag indicating that a plurality of the logic extents are assigned in overlap,

a data checking step of checking data of the physical extents assigned in the extent assignment list and the assignment information,

a monitoring step of instructing the data checking step to check at fixed time intervals, and

a control step of, when the physical extent of the same data exists, assigning the plurality of the logic extents to the physical extent in question in overlap to manage assignment.

(Supplementary note 16) The management method, of a disk array device according to Supplementary note 15, wherein

at the data checking step,

the physical extents assigned in the extent assignment list are checked one by one at each reception of an instruction from the monitoring step, and

when an overlap flag of the assignment information of the physical extent is invalid, data of a physical extent to be checked and data of all the physical extents in the extent assignment list are compared, and

when the data coincide with each other, at the control step, assignment of the physical extent to be checked is opened to assign other physical extent whose data coincides in the extent assignment list and set the overlap flag to be valid.

(Supplementary note 17) A management program operable in a disk array device which assigns, to a physical extent of a physical disk, a logic extent of a logic disk to which a host device makes an access, which program causes the disk array device to execute

a data checking processing of at the time of assignment of the logic extent to the physical extent, checking identity of data of the logic extent and data of the physical extent already assigned, and

a control processing of, when the physical extent of the same data exists, assigning a plurality of the logic extents to the physical extent in question in overlap to manage assignment.

(Supplementary note 18) The management program of a disk array device according to Supplementary note 17, comprising:

an extent assignment list which registers assignment information including a state of assignment of the logic extent and the physical extent and an overlap flag indicating that the plurality of the logic extents are assigned in overlap, wherein

when executing new assignment, assignment change and assignment opening of the logic extent and the physical extent in the control processing, registration, change and deletion of the assignment information of the extent assignment list are executed.

(Supplementary note 19) The management program of a disk array device according to Supplementary note 18, wherein

when a data write request is made to the logic extent yet to be assigned to the physical extent, write data and data of all the physical extents in the extent assignment list are compared in the data checking processing, and

when the data coincide with each other, the logic extent as a write target is made to correspond to a physical extent whose data coincides to register assignment information whose overlap flag is set to be valid at the extent assignment list without executing writing processing of the write data in the control processing, and

when the data fail to coincide with each other, the logic extent as a write target is assigned to new the physical extent to register assignment information including the assignment state in question and an invalid overlap flag at the extent assignment list and execute processing of writing the write data to the physical extent assigned in the control processing.

(Supplementary note 20) The management program of a disk array device according to Supplementary note 18, wherein

when a data write request is made to the logic extent already assigned to the physical extent, in the control processing, determination is made whether an overlap flag of the assignment information in the extent assignment list is valid or not, and

when the overlap flag fails to be valid, in the data checking processing, the write data and data of all the physical extents in the extent assignment list are compared, and

when the data coincide with each other, assignment to a physical extent whose data coincides is opened to make the logic extent as a write target correspond to the physical extent whose data coincides and register assignment information whose overlap flag is set to be valid at the extent assignment list without executing processing of writing the write data in the control processing, and

when the data fail to coincide with each other, processing is executed of writing the write data to the physical extent assigned to the logic extent as a write target in the control processing.

(Supplementary note 21) The management program of a disk array device according to Supplementary note 20, wherein

when the overlap flag is valid,

in the control processing, assignment information about the logic extent as a write target is cleared, and

in the data checking processing, the write data and data of all the physical extents in the extent assignment list are compared, and

when the data coincide with each other, the logic extent as a write target is made to correspond to a physical extent whose data coincides to register assignment information whose overlap flag is set to be valid at the extent assignment list without executing processing of writing the write data in the control processing, and

when the data fail to coincide with each other, the logic extent as a write target is assigned to new the physical extent to register assignment information including the assignment state in question and an invalid overlap flag at the extent assignment list and execute processing of writing the write data to the physical extent assigned in the control processing.

(Supplementary note 22) The management program of a disk array device according to Supplementary note 18, wherein

the assignment information includes a CRC of data of the physical extent assigned, and

when registering or changing the assignment information in the extent assignment list in the control processing, the CRC of the data of the physical extent is included in the assignment information.

(Supplementary note 23) A management program operable on a disk array device which assigns, to a physical extent of a physical disk, a logic extent of a logic disk to which a host device makes an access, wherein the disk array device has

an extent assignment list which registers assignment information including a state of assignment of the logic extent and the physical extent and an overlap flag indicating that a plurality of the logic extents are assigned in overlap,

a data checking processing of checking data of the physical extents assigned in the extent assignment list and the assignment information,

a monitoring processing of instructing the data checking processing to check at fixed time intervals, and

a control processing of, when the physical extent of the same data exists, assigning the plurality of the logic extents to the physical extent in question in overlap to manage assignment.

(Supplementary note 24) The management program of a disk array device according to Supplementary note 23, wherein

in the data checking processing,

the physical extents assigned in the extent assignment list are checked one by one at each reception of an instruction from the monitoring processing, and

when an overlap flag of the assignment information of the physical extent is invalid, data of a physical extent to be checked and data of all the physical extents in the extent assignment list are compared, and

when the data coincide with each other, in the control processing, assignment of the physical extent to be checked is opened to assign other physical extent whose data coincides in the extent assignment list and set the overlap flag to be valid.

What is claimed is:

1. A disk array device which assigns, to a physical extent of a physical disk, a logic extent of a logic disk to which a host device makes an access, comprising:
a data checking unit which, at the time of assignment of said logic extent to said physical extent, checks identity of data of said logic extent and data of said physical extent already assigned; and
a control unit which, when said physical extent of the same data exists, assigns a plurality of said logic extents to the physical extent in question in overlap to manage assignment.

2. The disk array device according to claim 1, further comprising:
an extent assignment list which registers assignment information including a state of assignment of said logic extent and said physical extent and an overlap flag indicating that the plurality of said logic extents are assigned in overlap, wherein
when executing new assignment, assignment change and assignment opening of said logic extent and said physical extent, said control unit registers, changes and deletes the assignment information of said extent assignment list.

3. The disk array device according to claim 2, wherein
when a data write request is made to said logic extent yet to be assigned to said physical extent, said data checking unit compares write data and data of all the physical extents in said extent assignment list,
when The data coincide with each other, said control unit makes said logic extent as a write target correspond to a physical extent whose data coincides and registers assignment information whose overlap flag is set to be valid at said extent assignment list without executing writing processing of said write data, and
when the data fail to coincide with each other, said control unit assigns said logic extent as a write target to new said physical extent and registers assignment information including the assignment state in question and an invalid overlap flag at said extent assignment list to execute processing of writing said write data to said physical extent assigned.

4. The disk array device according to claim 2, wherein
when a data write request is made to said logic extent already assigned to said physical extent, said control unit determines whether an overlap flag of the assignment information in said extent assignment list is valid or not,
when said overlap flag fails to be valid, said data checking unit compares the write data and data of all the physical extents in said extent assignment list,
when the data coincide with each other, said control unit opens assignment to a physical extent whose data coincides, makes said logic extent as a write target correspond to the physical extent whose data coincides and registers assignment information whose overlap flag is set to be valid at said extent assignment list without executing processing of writing said write data, and
when the data fail to coincide with each other, said control unit executes processing of writing said write data to said physical extent assigned to said logic extent as a write target.

5. The disk array device according to claim 4, wherein
when said overlap flag is valid,
said control unit clears assignment information about said logic extent as a write target, and
said data checking unit compares the write data and data of all the physical extents in said extent assignment list,
when the data coincide with each other, said control unit makes said logic extent as a write target correspond to a physical extent whose data coincides and registers assignment information whose overlap flag is set to be valid at said extent assignment list without executing processing of writing said write data, and
when the data fail to coincide with each other, said control unit assigns said logic extent as a write target to new said physical extent and registers assignment information including the assignment state in question and an invalid overlap flag at said extent assignment list to execute processing of writing said write data to said physical extent assigned.

6. The disk array device according to claim 2, wherein
said assignment information includes a CRC of data of said physical extent assigned,
wherein when registering or changing said assignment information in said extent assignment list, said control unit includes the CRC of the data of said physical extent in said assignment information.

7. A disk array device which assigns, to a physical extent of a physical disk, a logic extent of a logic disk to which a host device makes an access, comprising:
an extent assignment list which registers assignment information including a state of assignment of said logic extent and said physical extent and an overlap flag indicating that a plurality of said logic extents are assigned in overlap;
a data checking unit which checks data of said physical extents assigned in said extent assignment list and said assignment information;
a monitoring unit which instructs said data checking unit to check at fixed time intervals; and
a control unit which, when said physical extent of the same data exists, assigns the plurality of said logic extents to the physical extent in question in overlap to manage assignment.

8. The disk array device according to claim 7, wherein
said data checking unit
checks said physical extents assigned in said extent assignment list one by one at each reception of an instruction from said monitoring unit, and
when an overlap flag of the assignment information of said physical extent is invalid, compares data of a physical extent to be checked and data of all the physical extents in said extent assignment list, and
when the data coincide with each other, said control unit opens assignment of the physical extent to be checked to assign other physical extent whose data coincides in said extent assignment list and set the overlap flag to be valid.

9. A management method of a disk array device which assigns, to a physical extent of a physical disk, a logic extent of a logic disk to which a host device makes an access, comprising:
a data checking step of, at the time of assignment of said logic extent to said physical extent, checking identity of data of said logic extent and data of said physical extent already assigned; and
a control step of, when said physical extent of the same data exists, assigning a plurality of said logic extents to the physical extent in question in overlap to manage assignment.

10. The management method of a disk array device according to claim 9, comprising:
an extent assignment list which registers assignment information including a state of assignment of said logic extent and said physical extent and an overlap flag indicating that the plurality of said logic extents are assigned in overlap, wherein
when executing new assignment, assignment change and assignment opening of said logic extent and said physical extent at said control step, registration, change and deletion of the assignment information of said extent assignment list are executed.

11. The management method of a disk array device according to claim 10, wherein
when a data write request is made to said logic extent yet to be assigned to said physical extent, at said data checking step, write data and data of all the physical extents in said extent assignment list are compared, and
when the data coincide with each other, at said control step, said logic extent as a write target is made to correspond to a physical extent whose data coincides to register assignment information whose overlap flag is set to be valid at said extent assignment list without executing writing processing of said write data, and
when the data fail to coincide with each other, at said control step, said logic extent as a write target is assigned to new said physical extent and assignment information including the assignment state in question and an invalid overlap flag is registered at said extent assignment list to execute processing of writing said write data to said physical extent assigned.

12. The management method of a disk array device according to claim 10, wherein
when a data write request is made to said logic extent already assigned to said physical extent, at said control step, determination is made whether an overlap flag of the assignment information in said extent assignment list is valid or not, and
when said overlap flag fails to be valid, at said data checking step, the write data and data of all the physical extents in said extent assignment list are compared, and
when the data coincide with each other, at said control step, assignment to a physical extent whose data coincides is opened to make said logic extent as a write target correspond to the physical extent whose data coincides and register assignment information whose overlap flag is set to be valid at said extent assignment list without executing processing of writing said write data, and
when the data fail to coincide with each other, at said control step, processing is executed of writing said write data to said physical extent assigned to said logic extent as a write target.

13. The management method of a disk array device according to claim 12, wherein
when said overlap flag is valid,
at said control step, assignment information about said logic extent as a write target is cleared, and
at said data checking step, the write data and data of all the physical extents in said extent assignment list are compared, and
when the data coincide with each other, at said control step, said logic extent as a write target is made to correspond to a physical extent whose data coincides to register assignment information whose overlap flag is set to be valid at said extent assignment list without executing processing of writing said write data, and
when the data fail to coincide with each other, at said control step, said logic extent as a write target is assigned to new said physical extent to register assignment information including the assignment state in question and an invalid overlap flag at said extent assignment list and execute processing of writing said write data to said physical extent assigned.

14. The management method of a disk array device according to claim 10, wherein
said assignment information includes a CRC of data of said physical extent assigned, and
when registering or changing said assignment information in said extent assignment list at said control step, the CRC of the data of said physical extent is included in said assignment information.

15. A management method of a disk array device which assigns, to a physical extent of a physical disk, a logic extent of a logic disk to which a host device makes an access, comprising:
an extent assignment list which registers assignment information including a state of assignment of said logic extent and said physical extent and an overlap flag indicating that a plurality of said logic extents are assigned in overlap,
a data checking step of checking data of said physical extents assigned in said extent assignment list and said assignment information;
a monitoring step of instructing said data checking step to check at fixed time intervals; and
a control step of, when said physical extent of the same data exists, assigning the plurality of said logic extents to the physical extent in question in overlap to manage assignment.

16. The management method of a disk array device according to claim 15, wherein
at said data checking step,
said physical extents assigned in said extent assignment list are checked one by one at each reception of an instruction from said monitoring step, and
when an overlap flag of the assignment information of said physical extent is invalid, data of a physical extent to be checked and data of all the physical extents in said extent assignment list are compared, and
when the data coincide with each other, at said control step, assignment of the physical extent to be checked is opened to assign other physical extent whose data coincides in said extent assignment list and set the overlap flag to be valid.

17. A management program operable in a disk array device which assigns, to a physical extent of a physical disk, a logic extent of a logic disk to which a host device makes an access, which program causes said disk array device to execute
a data checking processing of at the time of assignment of said logic extent to said physical extent, checking identity of data of said logic extent and data of said physical extent already assigned, and
a control processing of, when said physical extent of the same data exists, assigning a plurality of said logic extents to the physical extent in question in overlap to manage assignment.

18. The management program of a disk array device according to claim 17, comprising:
an extent assignment list which registers assignment information including a state of assignment of said logic extent and said physical extent and an overlap flag indicating that the plurality of said logic extents are assigned in overlap, wherein
when executing new assignment, assignment change and assignment opening of said logic extent and said physical extent in said control processing, registration, change and deletion of the assignment information of said extent assignment list are executed.

19. A management program operable on a disk array device which assigns, to a physical extent of a physical disk, a logic extent of a logic disk to which a host device makes an access, wherein said disk array device has
an extent assignment list which registers assignment information including a state of assignment of said logic extent and said physical extent and an overlap flag indicating that a plurality of said logic extents are assigned in overlap,
a data checking processing of checking data of said physical extents assigned in said extent assignment list and said assignment information,
a monitoring processing of instructing said data checking processing to check at fixed time intervals, and
a control processing of, when said physical extent of the same data exists, assigning the plurality of said logic extents to the physical extent in question in overlap to manage assignment.

20. The management program of a disk array device according to claim 19, wherein
in said data checking processing,
said physical extents assigned in said extent assignment list are checked one by one at each reception of an instruction from said monitoring processing, and
when an overlap flag of the assignment information of said physical extent is invalid, data of a physical extent to be checked and data of all the physical extents in said extent assignment list are compared, and
when the data coincide with each other, in said control processing, assignment of the physical extent to be checked is opened to assign other physical extent whose data coincides in said extent assignment list and set the overlap flag to be valid.
